(19) United States
(12) Patent Application Publication
(10) Pub. No.: US 2016/0321637 A1
(43) Pub. Date: Nov. 3, 2016

(54) POINT OF SALE PAYMENT USING MOBILE DEVICE AND CHECKOUT CREDENTIALS

(71) Applicants: Kevin Carvalho, San Francisco, CA (US); James Dimmick, Foster City, CA (US)

(72) Inventors: Kevin Carvalho, San Francisco, CA (US); James Dimmick, Foster City, CA (US)

(21) Appl. No.: 15/143,231

(22) Filed: Apr. 29, 2016

Related U.S. Application Data
(60) Provisional application No. 62/155,300, filed on Apr. 30, 2015.

(51) Int. Cl. G06Q 20/20; G06Q 20/40; H04L 12/58; G06Q 20/10

(52) U.S. Cl. CPC G06Q 20/204; G06Q 20/10; G06Q 20/401; H04L 51/04

(57) ABSTRACT

A method and system of enrolling in a payment service is disclosed. Payment data may be received from a payment device at a point of sale device and may be used to fill out an enrollment for a payment service.

### BACKGROUND

In general, consumers are hesitant to try new payment products as consumers often have to provide very personal information. While the personal information is necessary to set up a payment account, some of the information is so private, it may be difficult to convince users to sign up. In addition, even though the new payment product may be extremely secure, consumers may not want to make the effort to fill in the necessary forms to open the payment product, even when the payment product may safe the consumer time in the long run.

### SUMMARY

A method and system of enrolling in a payment service is disclosed. Payment data may be received from a payment device at a point of sale device. The system may determine if the payment device or responsible party for the payment device is enrolled in a payment service. In response to a payment device and payment device responsible party being determined to not to be enrolled in a payment service, an enrollment node may be prepopulated in the payment service and a link to the enrollment node may be provided to the payment device responsible party. In response to the link being activated, verification data of the payment device may be accepted and in response to the verification data being verified, the payment device and payment device responsible party in the payment service may be enrolled in the payment service.

### BRIEF DESCRIPTION OF THE DRAWINGS

FIG. 1 is an illustration of the system including various servers and method steps performed by the servers;

FIG. 2 is an illustration of a user interface for using the system;

FIG. 3 is an illustration of some of the elements a sample computing system that may be physically configured to implement the method and system;

FIG. 4 is an illustration of a portable computing device; and

FIG. 5 is a user interface in accordance with the method.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

At a high level, the described system and method may be used to assist consumers or others responsible for a payment device enroll in an additional payment service. As a payment device issuers or others in the payment processing chain may have payment data necessary to fill in a majority of an application for an additional payment service, the payment data may be used to prefill an enrollment form for a consumer. As a result, a consumer will have to enter a minimum amount of data to enroll in the payment service and more consumers may be willing to sign up and use the payment service.

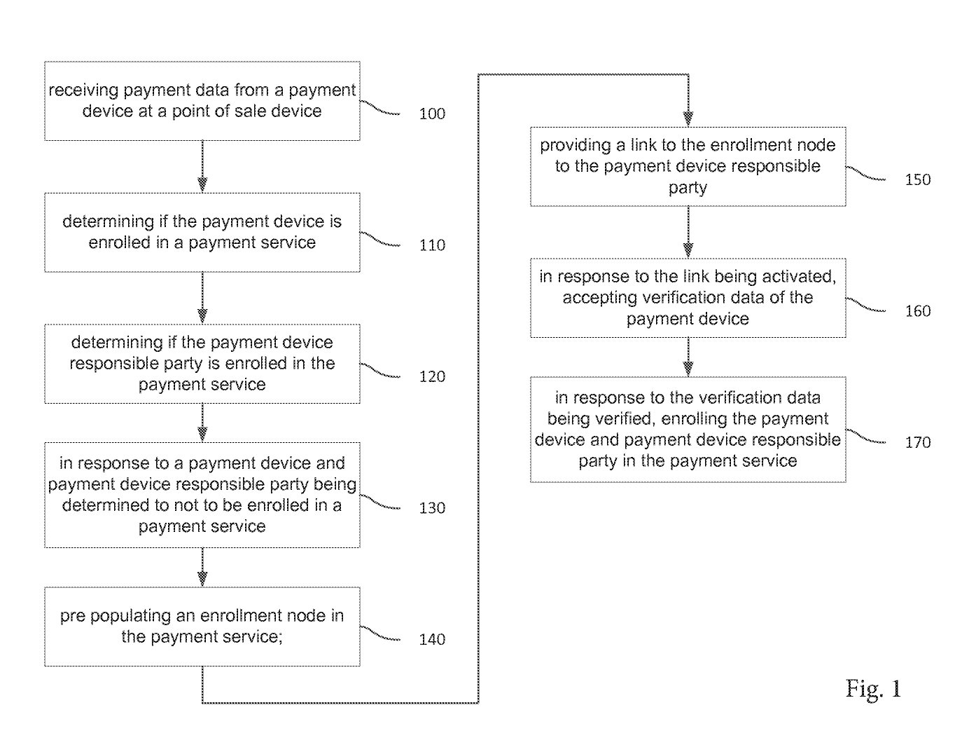

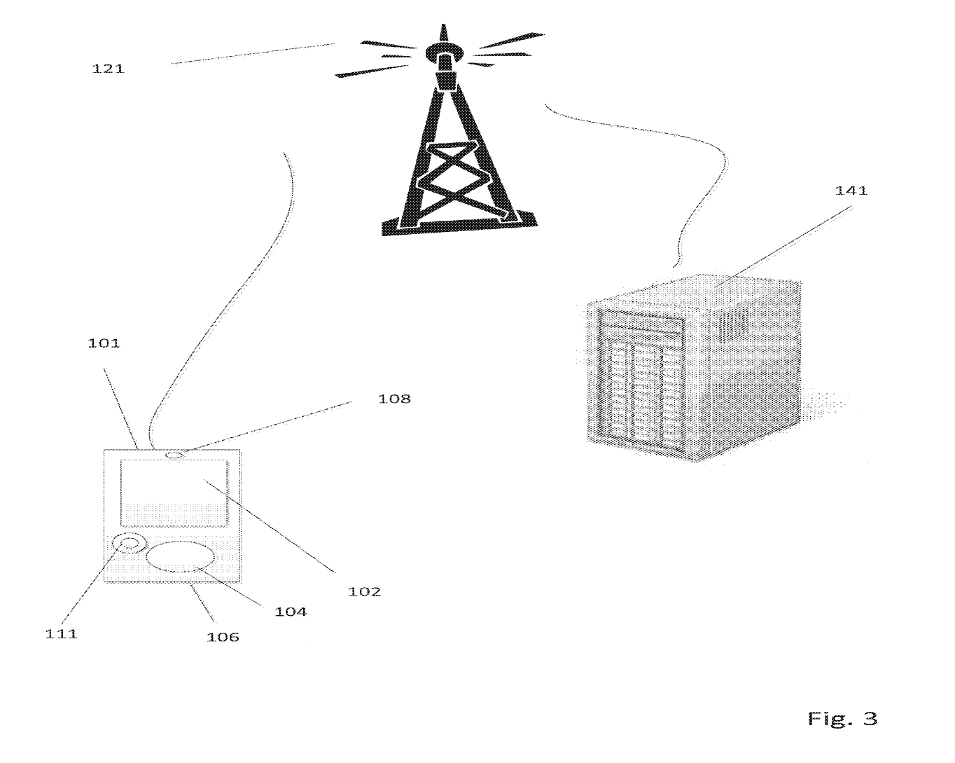

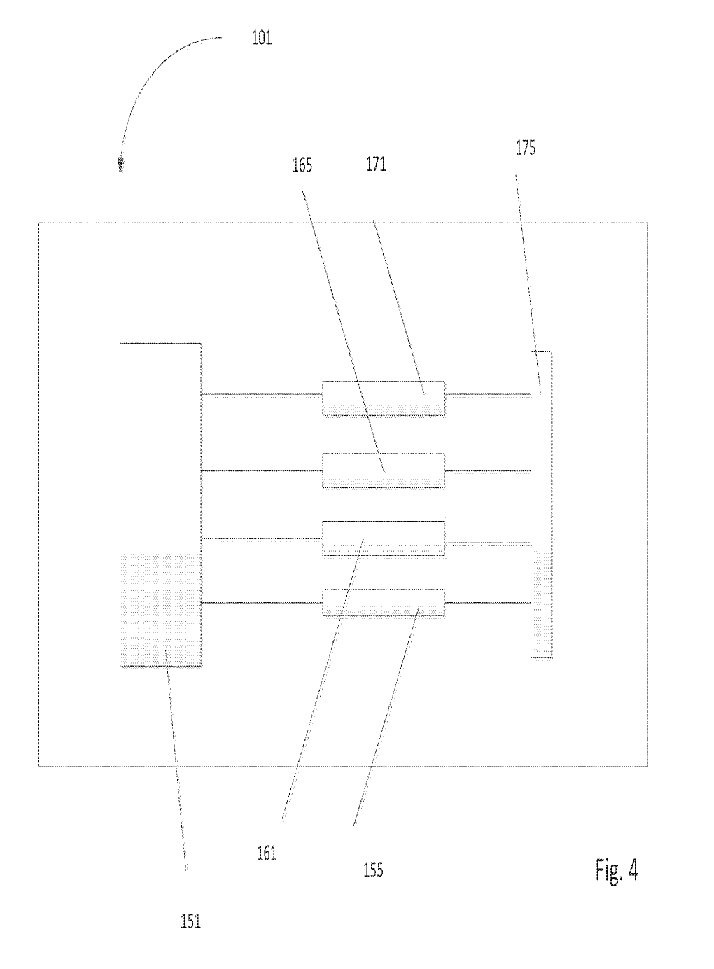

Referring to FIG. 1, a system may execute a method of enrolling in a payment service may be disclosed. Each step of the method may be performed on a server including instructions that, when executed by a processor, perform the action or block described herein. At block 100, a point of sale device 101 (FIGS. 3 and 4) may receive payment data from a payment device at the point of sale device. The payment device may be a credit card or other representation of a financial account which may have an account number on the front or part of a memory that may be part of the payment device such as a magnetic stripe or an electronic chip. In other embodiments, the payment device may be a computer application. In yet other embodiments, radio frequency signals may be used to communicate the account information.

Payment data may vary based on the payment device. It may include identification data representing a responsible party for the payment device and account data representing an account that is represented by the payment device such as on a standard credit card. In other embodiments, the payment data may be less such as a pre-paid debit card which may only have an account number. Further, in some embodiments, the payment data may be a code and the code which may be used by a backend system to determine an account number. In yet additional embodiments, the payment data may be more expansive and may include further data such a pin number, a token, a key, an electronic key, a bank name, a routing path, one or more encrypted values, etc.

An enrollment server 110 may execute instructions to determine if the payment device is enrolled in a payment service. Identification data of the payment device such as the account number may be communicated to see if the payment device is enrolled in the payment service. In some embodiments, the account number is communicated from the point of sale device directly to the payment service and in other embodiments, the payment device may be communicated from the point of sale to a back end server where the account number is retrieved and then to the payment service. In some embodiments, the communication to check the identification data may be over a proprietary network such as a payment network and in other embodiments, the communication may be over a more traditional network such as the Internet.

Further, in some embodiments, the account data may be communicated to a dedicated payment service verification service. In this situation, the risk may be less and the response may be quicker as the verification service may have its own protocol and response system. As mentioned previously, the account data may be communicated over the payment network or another network to the payment service verification service.

The payment service may be a subsystem or service that accepts a log in and a password, communicates the log in and password to a backend server where the log in and password are verified and an approval signal is communicated to the seller and the transaction is completed. Account data may be kept in back end servers and may only be accessed for billing purposes. The payment service may be easier for consumers as the payment service may operate as an application on a device such as a portable computing device like a smart phone. Of course, the payment service may operate in a variety of ways such as receiving a biometric input instead of a login, may require multiple forms of identification, etc.

At block 120, the enrollment server 110 may execute further instructions to determine if the payment device responsible party is enrolled in the payment service. In some situations, a responsible party may have more than one account and some accounts may be enrolled in the payment service and other accounts may not be enrolled in the payment account service. Thus, if the responsible party already has one account in the system, it may be even easier to pre-fill out a form for an additional account to be added to the payment system. Further, a different user interface may be provided to emphasize to the user that only an additional card may be added to the payment system so that the user may feel recognized.

At block 130, the enrollment server 110 may execute instructions to analyze the determinations of whether a payment device and payment device responsible party were determined to be enrolled in a payment service. If the responsible party is enrolled but the account is not enrolled, a first graphical user interface may be used. If neither the responsible party is enrolled nor the account is not enrolled, a second graphical user interface may be used. If the responsible party is enrolled and the account is enrolled, the system and method may end or an option may be displayed to use the payment system. Finally, if the responsible party is not enrolled but the account is enrolled, further analysis may be performed as the responsible party should be part of the payment system if an account belonging to the responsible party is part of the payment system.

A pre-populating server 140 may execute instructions to pre-populate or fill in an enrollment node in the payment service. Pre-populating the enrollment node in the payment service may include creating an enrollment form prefilled with data from the payment data. In other embodiments, the relevant data may be obtained from the issuer of the payment device. In another embodiments, the relevant data may be obtained through the payment network.

At block 150, the prepopulating server 140 may execute an instruction to provide a link for the enrollment node to the payment device responsible party. The link may be a unique address controlled and secured by the payment system. In some embodiments, the enrollment node may include an interactive form with the relevant data prefilled. The node may be a web site location, for example. The node also may be a graphical user interface that is in communication with a server at the payment service.

The node may be communicated in a variety of ways. Some possible manners of communication include at least one of an SMS message, an email, a proprietary electronic message service, a notification in an app and a notification in a network application. The selection of the communication manner may include determining the type of communication device available to the user. In some embodiments, the message may proceed to a consumer's smart phone which may have rich graphical capabilities. In other embodiments, the user may not have a personal computing device so the message may be communicated to a modern point of sale device currently being used by the user. The communication may be in real time or may follow at a point in the future.

A verification server 160, in response to the link being activated, may execute instructions to receive verification data of the payment device. Verification data may be many and varied. A PIN may be an example as may be a mother's maiden name. Verification questions of the authorized user may be set up in advance and may be selected at random.

At block 170, in response to the verification data being verified, the enrollment server 110 may enroll the payment device and payment device responsible party in the payment service.

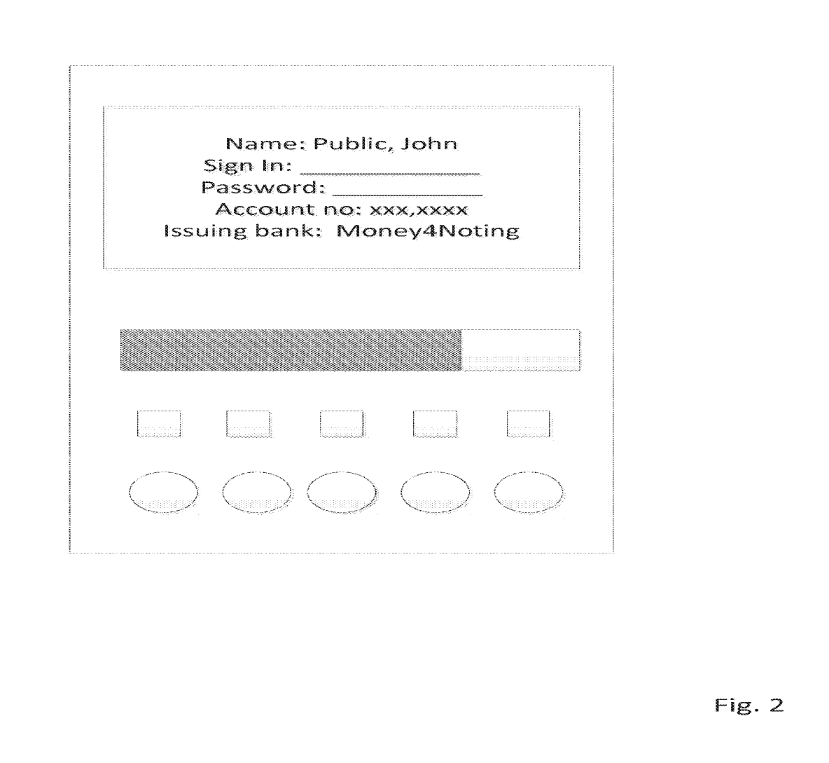

FIG. 2 may be a sample user interface for enrolling in the payment service. As mentioned previously, the user interface may be prefilled with a vast majority of the necessary information to sign up for the payment service. In FIG. 2, all that may be needed is a sign in and a password. The progress bar may be 75% across the display as the sign up is almost complete. Of course, like with any graphical user interface, the interface may have a variety of additional options and may be adjusted in a variety of ways. The graphical user interface may automatically update and display the desired material based on the known data. It also may allow a user to further review the payment system such as the rules and regulations if the user desires to read them.

FIG. 3 may be a high level illustration of some of the elements a sample computing system that may be physically configured to implement the method and system. The computing system may be a dedicated computing device 141 or server, a dedicated portable computing device 101 such as a point of sale device, an application on the server 141, an application on the portable computing device 101 or a combination of all of these. While FIG. 3 illustrates only one server 141, persons or ordinary skill in the art of computing systems in general and the system of enrolling in a payment service in particular will recognize that multiple servers may be used. For example, the server 141 may include several servers such as an enrollment server 110, a pre-populating server 140, a verification server 160, a back end server, or other servers for the system described herein. FIG. 4 may be a high level illustration of a portable computing device 101, such as the point of sale device, communicating with a remote computing device 141 but the application may be stored and accessed in a variety of ways. In addition, the application may be obtained in a variety of ways such as from an app store, from a web site, from a store WiFi system, etc. There may be various versions of the application to take advantage of the benefits of different computing devices, different languages and different API platforms.

In one embodiment, a portable computing device 101 may be a device that operates using a portable power source 155 such as a battery. The portable computing device 101 may also have a display 102 which may or may not be a touch sensitive display. More specifically, the display 102 may have a capacitance sensor, for example, that may be used to provide input data to the portable computing device 101. In other embodiments, an input pad 104 such as arrows, scroll wheels, keyboards, etc., may be used to provide inputs to the portable computing device 101. In addition, the portable computing device 101 may have a microphone 106 which may accept and store verbal data, a camera 108 to accept images and a speaker 111 to communicate sounds.

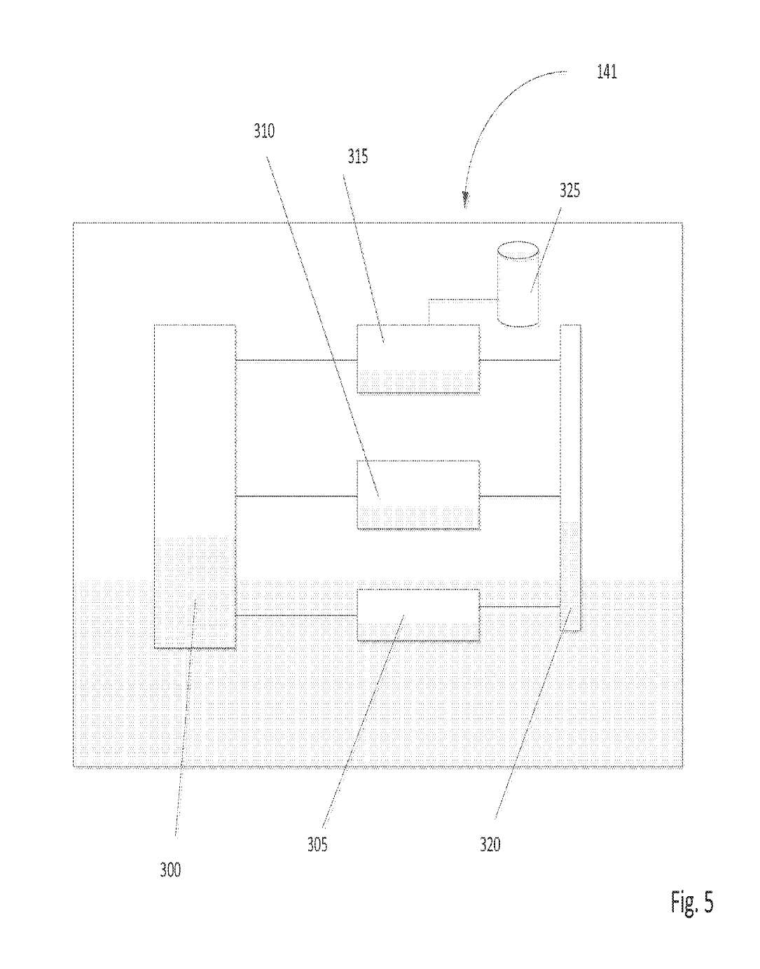

The portable computing device 101 may be able to communicate with a computing device 141 or a plurality of computing devices 141 that make up a cloud of computing devices 111. The portable computing device 101 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 141 or may be through a communication network 121 such as cellular service, through the Internet, through a private network, through Bluetooth, etc. FIG. 4 may be a simplified illustration of the physical elements that make up a portable computing device 101 and FIG. 5 may be a simplified illustration of the physical elements that make up a server type computing device 141.

FIG. 4 may be a sample portable computing device 101 that is physically configured according to be part of the system. The portable computing device 101 may have a processor 151 that is physically configured according to computer executable instructions. It may have a portable power supply 155 such as a battery which may be rechargeable. It may also have a sound and video module 161 which assists in displaying video and sound and may turn off when not in use to conserve power and battery life. The portable computing device 101 may also have volatile memory 165 and non-volatile memory 171. It may have GPS capabilities that may be a separate circuit or may be part of the processor 150. There also may be an input/output bus 175 that shuttles data to and from the various user input devices such as the microphone 106, the camera 108 and other inputs 102, etc. It also may control communicating with the networks, either through wireless or wired devices. Of course, this is just one embodiment of the portable computing device 101 and the number and types of portable computing devices 101 is limited only by the imagination.

The physical elements that make up the remote computing device 141 such as the remote institution may be further illustrated in FIG. 5. At a high level, the computing device 141 may include a digital storage such as a magnetic disk, an optical disk, flash storage, non-volatile storage, etc. Structured data may be stored in the digital storage such as in a database. The server 141 may have a processor 300 that is physically configured according to computer executable instructions. It may also have a sound and video module 305 which assists in displaying video and sound and may turn off when not in use to conserve power and battery life. The server 141 may also have volatile memory 310 and non-volatile memory 315.

The database 325 may be stored in the memory 310 or 315 or may be separate. The database 325 may also be part of a cloud of computing device 141 and may be stored in a distributed manner across a plurality of computing devices 141. There also may be an input/output bus 320 that shuttles data to and from the various user input devices such as the microphone 106, the camera 108, the inputs 102, etc. The input/output bus 320 also may control of communicating with the networks, either through wireless or wired devices. In some embodiments, the application may be on the local computing device 101 and in other embodiments, the application may be remote 141. Of course, this is just one embodiment of the server 141 and the number and types of portable computing devices 141 is limited only by the imagination.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving payment systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A system for enrolling in a payment service comprising:
a point of sale device including instructions for execution on a point of sale device processor to receive payment data from a payment device at the point of sale device;
an enrollment server including instructions for execution on an enrollment server processor to determine if the payment device is enrolled in a payment service and determine if the payment device responsible party is enrolled in the payment service;
a pre-populating server including instructions for execution on a pre-populating server processor to, in response to a payment device and payment device responsible party being determined to not to be enrolled in a payment service, pre-populate an enrollment node in the payment service and provide a link to the enrollment node to the payment device responsible party; and
a verification server including instructions for execution on a verification server processor to, in response to the link being activated, accept verification data of the payment device.

2. The system of claim 1, wherein the enrollment server includes further instructions for execution on the enrollment server processor to, in response to the verification data being verified, enroll the payment device and payment device responsible party in the payment service.

3. The system of claim 1, wherein the payment service comprises a subsystem including a communication server, the communication server including instructions for execution on a communication server processor to accept a log in and a password, and communicate the log in and password to the verification server, the verification server including further instructions for execution on the verification server processor to verify the log in and password.

4. The system of claim 1, wherein the payment data comprises identification data representing a responsible party for the payment device and account data representing an account that is represented by the payment device, and the enrollment server instruction to determine if the payment device is enrolled in a payment service further comprises an instruction for execution on the enrollment server processor to communicate the account data to a payment service verification service.

5. The system of claim 1, wherein the pre-populating server instruction to pre-populate the enrollment node in the payment service further comprises an instruction to create an enrollment form prefilled with data from the payment data, retrieve relevant data from the issuer of the payment device through a payment network.

6. A method of enrolling in a payment service comprising:
receiving payment data from a payment device at a point of sale device;
determining if the payment device is enrolled in a payment service;
determining if the payment device responsible party is enrolled in the payment service;
in response to a payment device and payment device responsible party being determined to not to be enrolled in a payment service,
pre populating an enrollment node in the payment service;
providing a link to the enrollment node to the payment device responsible party;
in response to the link being activated, accepting verification data of the payment device;
in response to the verification data being verified, enrolling the payment device and payment device responsible party in the payment service.

7. The method of claim 6, wherein the payment service comprises a service that accepts a log in and a password, communicates the log in and password to a backend server where the log in and password are verified.

8. The method of claim 7, wherein in response to the login and password being verified, a payment account that is associated with the login and password is used for a transaction.

9. The method of claim 6, wherein the payment data comprises identification data representing a responsible party for the payment device and account data representing an account that is represented by the payment device.

10. The method of claim 9, wherein determining if the payment device is enrolled in a payment service further comprising communicating the account data to a payment service verification service.

11. The method of claim 10, wherein the account data is communicated over the payment network.

12. The method of claim 9, wherein determining if the payment device responsible party is enrolled in the payment service further comprises communicating the identification data to a payment service verification service.

13. The method of claim 12, wherein the account data is communicated over the payment network.

14. The method of claim 6, wherein pre populating the enrollment node in the payment service comprises creating an enrollment form prefilled with data from the payment data.

15. The method of claim 14, further comprising retrieving relevant data from the issuer of the payment device.

16. The method of claim 15, further comprising retrieving the relevant data through the payment network.

17. The method of claim 6, wherein enrollment node comprises an interactive form with the relevant data prefilled.

18. The method of claim 6, wherein the node is communicated by at least one of an SMS message, an email, a proprietary electronic message service, a notification in an app and a notification in a network application.

19. The method of claim 6, wherein the node is a web address.

20. The method of claim 6, wherein the node comprises a graphical user interface that is in communication with a server at the payment service.
